(19) United States
(12) Patent Application Publication
(10) Pub. No.: US 2021/0063314 A1
(43) Pub. Date: Mar. 4, 2021

(54) USE OF A BACKSIDE ROUGHENED SAMPLE FOR MULTIPLE OPTICAL MEASUREMENTS TO IMPROVE THIN FILM FABRICATIONS

(71) Applicant: Halliburton Energy Services, Inc., Houston, TX (US)

(72) Inventors: Jian Li, Bellaire, TX (US); Christopher Michael Jones, Katy, TX (US); Bin Dai, Spring, TX (US); Jimmy M. Price, Cypress, TX (US)

(21) Appl. No.: 16/981,445

(22) PCT Filed: May 17, 2018
(86) PCT No.: PCT/US2018/033070

§ 371 Date: Sep. 16, 2020

(51) Int. Cl. G01N 21/84; G01N 21/21; G01N 21/59; G01N 21/55; G01B 11/06

(52) U.S. Cl. CPC G01N 21/8422; G01N 21/211; G01N 21/59; G01N 2021/8416; G01B 11/0625; G01N 2021/8427; G01N 21/55

(57) ABSTRACT

An optical device fabrication system includes a witness sample having a roughened backside that is capable of both optical transmission and ellipsometry measurement analysis. The optical device can be an integrated computing element core.

### BACKGROUND

The present disclosure relates to optical elements and, more particularly, to improved techniques for the design and manufacture of optical processing elements for use in optical computing devices.

Optical computing devices can be used to analyze and monitor a sample substance in real time. Such optical computing devices will often employ a light source that emits electromagnetic radiation that reflects from or is transmitted through the sample and optically interacts with an optical processing element to determine quantitative and/or qualitative values of one or more physical or chemical properties of the substance being analyzed. The optical processing element may be, for example, an integrated computational element (ICE), also referred to as an “ICE core”. ICE core is a trademark of Halliburton Energy Services, Inc. and is registered in the U.S. Patent and Trademark Office. Each ICE Core® can be designed to operate over a continuum of wavelengths in the electromagnetic spectrum from the vacuum-UV to infrared (IR) ranges, or any sub-set of that region. Electromagnetic radiation that optically interacts with the sample substance is changed by the ICE core so as to be measured by a detector. The output of the detector can be processed and correlated to a physical or chemical property of the substance being analyzed.

A traditional ICE core includes a substrate base and multiple optical thin film layers consisting of various materials whose index of refraction and size (e.g., thickness) varies between each layer. An ICE core design refers to the substrate base along with the number and thickness of the respective layers of the ICE core, and the complex refractive indices of these layers.

### BRIEF DESCRIPTION OF THE DRAWINGS

FIG. 1 illustrates an exemplary integrated computational element, according to one or more embodiments.

FIG. 2 illustrates a block diagram of an optical computing device configured to determine one or more characteristics of a sample, according to one or more embodiments of the present disclosure.

FIG. 3 is a graph of transmission versus wavelength for BK7 glass.

FIG. 4 is an illustration of incoherent addition difference between glass with a smooth backside and glass with a roughened backside.

FIG. 5 is a graph of experimental data between glass with a smooth backside and glass with a roughened backside.

FIG. 6 is a graph of experimental data between glass with a smooth backside and glass with a roughened backside.

FIG. 7 is a graph of experimental data between glass with a smooth backside and glass with a roughened backside.

FIG. 8 illustrates a flowchart providing an exemplary method of fabricating an ICE core, according to one or more embodiments of the present disclosure.

FIG. 9 illustrates a flowchart providing an exemplary method of determining whether a roughened witness sample of an ICE core has roughness within an acceptable range, according to one or more embodiments

### DETAILED DESCRIPTION

The following detailed description illustrates embodiments of the present disclosure. These embodiments are described in sufficient detail to enable a person of ordinary skill in the art to practice these embodiments without undue experimentation. It should be understood, however, that the embodiments and examples described herein are given by way of illustration only, and not by way of limitation. Various substitutions, modifications, additions, and rearrangements may be made that remain potential applications of the disclosed techniques. Therefore, the description that follows is not to be taken as limiting on the scope or applications of the appended claims. In particular, an element associated with a particular embodiment should not be limited to association with that particular embodiment but should be assumed to be capable of association with any embodiment discussed herein.

Optical computing devices can be used to analyze and monitor a sample substance in real time. Such optical computing devices will often employ a light source that emits electromagnetic radiation that reflects from or is transmitted through the sample and optically interacts with an optical processing element to determine quantitative and/or qualitative values of one or more physical or chemical properties of the substance being analyzed. The optical processing element may be, for example, an integrated computational element core (“ICE Core®”). Each ICE Core® can be designed to operate over a continuum of wavelengths in the electromagnetic spectrum from the vacuum-UV to infrared (IR) ranges, or any sub-set of that region. Electromagnetic radiation that optically interacts with the sample substance is changed by the ICE core so as to be measured by a detector. The output of the detector can be processed and correlated to a physical or chemical property of the substance being analyzed.

A traditional ICE core includes a substrate base and multiple optical thin film layers consisting of various materials whose index of refraction and size (e.g., thickness) varies between each layer. An ICE core design refers to the substrate base along with the number and thickness of the respective layers of the ICE core, and the complex refractive indices of these layers.

As used herein, the term “characteristic” refers to a chemical, mechanical, or physical property of a substance or a sample of the substance. The characteristic of a substance may include a quantitative or qualitative value of one or more chemical constituents or compounds present therein or any physical property associated therewith. Illustrative characteristics of a substance that can be analyzed with the help of the optical processing elements described herein can include, for example, chemical composition (e.g., identity and concentration in total or of individual components), phase presence (e.g., oil, gas, brines, etc.), state of matter (solid, liquid, gas, emulsion, mixtures thereof, etc.), lithology of the formation (e.g. the concentration ratio of shale, sandstone, limestone and dolomite, the amount of sand, grain size in the formation, etc.), impurity content, pH, alkalinity, viscosity, density, ionic strength, total dissolved solids, salt content (e.g., salinity), porosity, opacity, bacteria content, total hardness, transmittance, state of matter (solid, liquid, gas, emulsion, mixtures thereof, etc.), combinations thereof, and the like.

As used herein, the term “electromagnetic radiation” refers to radio waves, microwave radiation, terahertz, infrared and near-infrared radiation, visible light, ultraviolet light, X-ray radiation and gamma ray radiation.

As used herein, the term “fluid” refers to any substance that is capable of flowing, including particulate solids, liquids, gases, slurries, emulsions, powders, muds, glasses, combinations thereof, and the like. In some embodiments, the fluid can be an aqueous fluid, including water or the like. In some embodiments, the fluid can be a non-aqueous fluid, including organic compounds, more specifically, hydrocarbons, oil, a refined component of oil, petrochemical products, and the like. In some embodiments, the fluid can be a treatment fluid or a formation fluid. Fluids can include various flowable mixtures of solids, liquid and/or gases. Illustrative gases that can be considered fluids according to the present embodiments include, for example, air, nitrogen, carbon dioxide, argon, helium, hydrogen disulfide, mercaptan, thiophene, methane, ethane, butane, and other hydrocarbon gases, and/or the like.

As used herein, the term “optical computing device” refers to an optical device that is configured to receive an input of electromagnetic radiation associated with a substance and produce an output of electromagnetic radiation from an optical processing element arranged within or otherwise associated with the optical computing device. The optical processing element may be, for example, an integrated computational element (ICE core). The electromagnetic radiation that optically interacts with the optical processing element is changed so as to be readable by a detector, such that an output of the detector can be correlated to a particular characteristic of the substance being analyzed. The output of electromagnetic radiation from the optical processing element can be reflected, transmitted, and/or dispersed electromagnetic radiation. Whether the detector analyzes reflected, transmitted, or dispersed electromagnetic radiation may be dictated by the structural parameters of the optical computing device as well as other considerations known to those skilled in the art.

As used herein, the term “optically interact” or variations thereof refer to the reflection, transmission, scattering, diffraction, or absorption of electromagnetic radiation either on, through, or from an optical processing element (e.g., an integrated computational element) or a substance being analyzed with the help of the optical processing element. Accordingly, optically interacted light refers to electromagnetic radiation that has been reflected, transmitted, scattered, diffracted, or absorbed by, emitted, or re-radiated, for example, using an optical processing element, but may also apply to optical interaction with a substance.

As used herein, the term “sample,” or variations thereof, refers to at least a portion of a substance of interest to be tested or otherwise evaluated using the optical computing devices described herein. The sample includes the characteristic of interest, as defined above, and may be any fluid, as defined herein, or otherwise any solid substance or material such as, but not limited to, rock formations, concrete, other solid surfaces, etc.

The present application describes improved methods for designing and manufacturing optical processing elements, such as ICE cores, for use in optical computing devices. In operation, an ICE core is capable of distinguishing electromagnetic radiation related to a characteristic of interest of a substance from electromagnetic radiation related to other components of the substance.

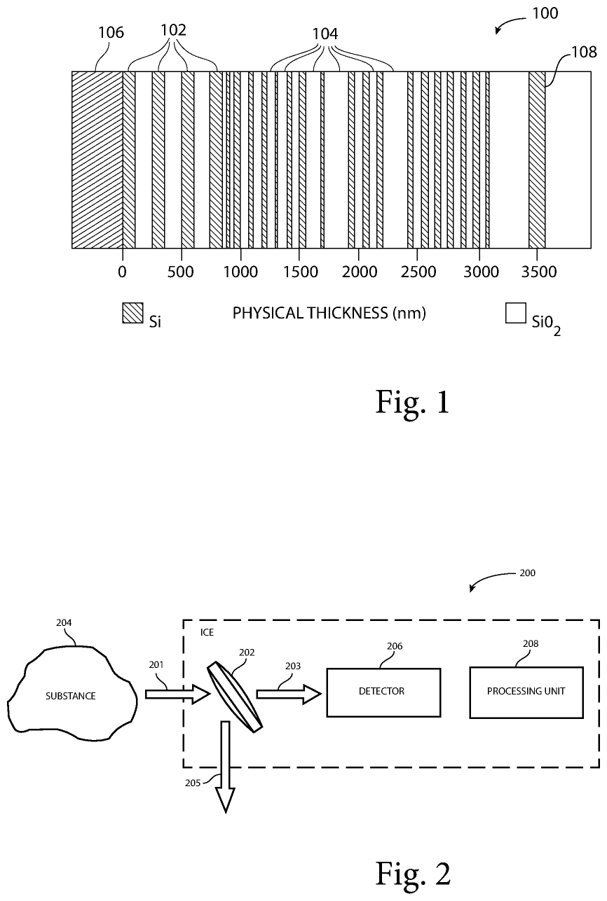

Referring to FIG. 1, illustrated is an ICE core 100. As illustrated, the ICE core 100 includes a base substrate 106 and a plurality of alternating thin film layers shown as layers 102 and 104. The first layers 102 are made of a material that exhibits a high index of refraction, such as silicon (Si), and the second layers 104 are made of a material that exhibits a low index of refraction, such as quartz (SiO2). Other examples of materials that might be used include, but are not limited to, niobia and niobium, germanium and germania, MgF, SiO, and other high and low index materials generally known in the art. The layers 102, 104 are strategically deposited on an optical substrate 106, such as BK-7 optical glass. In other embodiments, the substrate 106 may be another type of optical substrate, such as another optical glass, silica, sapphire, silicon, germanium, zinc selenide, zinc sulfide, or various plastics such as polycarbonate, polymethylmethacrylate (PMMA), polyvinylchloride (PVC), diamond, ceramics, combinations thereof, and the like.

At the opposite end (e.g., opposite the substrate 106 in FIG. 1), the ICE core 100 may include a layer 108 that is generally exposed to the environment of the device or installation. The number of layers 102, 104 and the thickness of each layer 102, 104 are determined from the spectral attributes acquired from a spectroscopic analysis of a characteristic of the substance being analyzed using a conventional spectroscopic instrument. The spectrum of interest of a given characteristic typically includes any number of different wavelengths.

It should be understood that the ICE core 100 depicted in FIG. 1 does not in fact represent any particular ICE core configured to detect a specific characteristic of a given substance, but is provided for purposes of illustration only. The thickness of substrate 106, the number of layers 102, 104 and their relative thicknesses are not necessarily drawn to scale, and therefore should not be considered limiting of the present disclosure.

FIG. 2 illustrates a block diagram of an optical computing device 200 configured to determine one or more characteristics of a sample 204 in accordance with some embodiments of the present disclosure. Optical computing device 200 may include an integrated computational element (ICE) 202 configured to receive electromagnetic radiation 201 from a sample 204. When electromagnetic radiation interacts with sample 204, unique physical and/or chemical information about sample 204 may be encoded in electromagnetic radiation 201 that is reflected from, transmitted through or radiated from sample 204. Information associated with each different characteristic may be encoded in electromagnetic radiation 201. ICE 202 is an optical element whose spectral property is convolved with electromagnetic radiation 201 to produce an altered electromagnetic radiation 203 in order to increase the ability to detect properties of interest of a sample 204. ICE 202 can be utilized to reduce or eliminate unwanted information and/or to enhance the wanted information in electromagnetic radiation 201, which can greatly increase the possibility of obtaining useful information from sample 204.

Optical computing device 200 may include a detector 206 configured to receive transmitted electromagnetic radiation 203 from ICE 202. Detector 206 may include any suitable apparatus, system, or device configured to detect the intensity of transmitted electromagnetic radiation 203 and generate a signal related to the intensity of transmitted electromagnetic radiation 203 received from ICE 202. For example, detector 206 may be configured to generate a voltage related to the intensity of transmitted electromagnetic radiation 203. Detector 206 may communicate the signal (e.g., voltage signal) related to the intensity of transmitted electromagnetic radiation 203 to a processing unit 208. Examples of detectors include split detectors, quad detectors, and array detectors.

The processing unit 208 may be configured to receive the signal communicated from detector 206 and correlate the received signal with the characteristic of which ICE 202 is configured to detect. For example, ICE 202 may be configured to detect temperature of sample 204 and the intensity of transmitted electromagnetic radiation 203 transmitted from ICE 202 may accordingly be related to the temperature of sample 204. Accordingly, detector 206 may generate a voltage signal based on the intensity of electromagnetic radiation 203 and may communicate the voltage signal to processing unit 208. Processing unit 208 may then correlate the received voltage signal with a temperature such that processing unit 208 may determine a temperature of sample 204.

Processing unit 208 may include a processor that is any system, device, or apparatus configured to interpret and/or execute program instructions and/or process data associated with the optical computing device 200. The processor may be, without limitation a microprocessor, microcontroller, digital signal processor (DSP), application specific integrated circuit (ASIC), or any other digital or analog circuitry configured to interpret and/or execute program instructions and/or process data.

In embodiments, multiple ICEs 202 may be placed in parallel, where each ICE 202 is configured to detect a particular characteristic of interest. In such embodiments, a beam splitter may divert a portion of the electromagnetic radiation from the substance being analyzed to each ICE 202. Each ICE 202, in turn, may be communicatively coupled to detector 206 or array of detectors 206 configured to detect an output of electromagnetic radiation from the ICE 202. Parallel configurations of ICEs 202 may be particularly beneficial for applications that require low power inputs and/or no moving parts. Parallel configurations of ICE's may also be particularly beneficial for applications where changes in characteristic values are rapid, such as high velocity flows.

In still additional embodiments, multiple ICE 202 may be placed in series, such that characteristics are measured sequentially at different locations and times. For example, in some embodiments, a characteristic can be measured in a first location using a first ICE 202, and the characteristic can be measured in a second location using a second ICE 202. In other embodiments, a first characteristic may be measured in a first location using a first ICE 202, and a second characteristic may be measured in a second location using a second ICE 202.

Although the operation of ICE 202 is often illustrated in the optical transmission mode, it is readily understood that ICE can operate as well in other optical modes, such as reflection, absorption, transflectance, Raman, Brillion, and Raleigh scattering modes, emittance or fluorescent modes, as well as evanescent modes known to those skilled in the art. In addition, components of ICE 202 may also be realized with a variety of other techniques. These include, but are not limited to, holographic optical elements (HOE's), phase gratings, optical gratings, Digital Light Pipe (DLP) devices, liquid crystal devices, photo-acoustic devices, and even naturally occurring substances such as water (e.g. in a curvette or holder) and gases (e.g. water vapor, CO, CO2, methane, hydrocarbon gases, NO and NOx nitrogen gases, etc).

There are a wide variety of implementations that may be employed to create ICE. In one embodiment, ICE 202 may include a plurality of alternating layers of optical elements (e.g., silicon, germanium, or other similar materials) with transmissive, reflective, and/or absorptive properties suitable for detecting a characteristic of interest. The multiple layers may have different refractive indices. By properly selecting the materials of the layers and their spacing, ICE 202 can be made to selectively transmit, absorb, and/or reflect predetermined fractions of electromagnetic radiation at different wavelengths.

Once a desired ICE core design is selected for fabrication, the chosen ICE core design may then be loaded into a fabrication computer program configured to instruct an associated fabrication machine or module to physically create or manufacture the ICE core. The fabrication computer program may be configured to receive and/or download the specifications for the desired ICE core design, and physically create a corresponding ICE core by methodically depositing the various layers of the ICE core to the specified layer thicknesses.

It is critical that the optical transmission spectrum closely follows the design. Even slight deviations, i.e., those resulting from the film thickness non-uniformity, may degrade the ICE performance to a failure level.

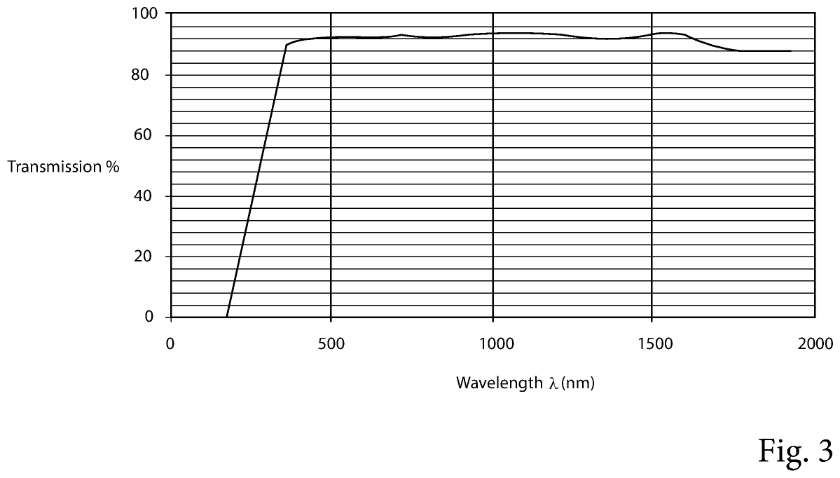

The ICE core substrate may be any type of optical substrate having the properties desired, such as, for a non-limiting example, an optical glass referred to as BK-7 optical glass. A graph of transmissibility verses wavelength for BK7 glass is shown in FIG. 3. It shows high and consistent transmission rates between 400-2000 nm.

In a fabrication process of thin film optical elements, witness samples, also called test pieces, are used to ensure that the actual part is made to match your specific desired ICE core design and your application. Multiple witness samples are typically placed together with the product samples for the process monitor/control purpose. For example in a batch of 200 product samples there may be four witness samples. These witnesses are measured either continually or stepwise during the process. Typical measurement types include intensity-based transmission and reflectance, as well as polarization-based ellipsometry whose geometry could be either reflective-based or transmission-based. The measured data are analyzed with optical models, and the analysis results provide critical information on the process parameters such as deposition rates and materials optical properties. This information can then be fed back to the control loop, either automatically or manually, to determine the key control parameters, such as the electron beam power and/or time length of depositions, of the remaining process steps in order to achieve optimized performance of the final products.

It is desirable that at least one witness sample should exist for each of the optical transmission, reflectance, and ellipsometry measurements, as each of them has unique advantages and disadvantages, and only a complementary combination of them would provide the comprehensive information of the process. However, due to the inevitable non-uniformities, different samples often need to be analyzed independently, which increases the number of free parameters and the associated data correlation (multiple answers with similar performance). As a result, the uncertainties in the modeling increase. In addition, multiple witness samples may not be physically available if the system's space is limited or if the cost of a wasted product spot is too high, as witnesses usually cannot be used as a product. It would be ideal if all the optical measurements can be done on a single witness sample.

Conventionally, it is considered that the requirements for the witness samples of the optical transmission, reflectance, and ellipsometry are in conflict with each other. (a) For optical transmission, the sample should be as smooth as possible on both the top and bottom surfaces. (b) For ellipsometry, the most common geometry is reflection-based. In this case the witness' bottom surface needs to me roughed in order to minimize the depolarization effect caused by the incoherent addition of lights reflected from the top and bottom surfaces. In the rarer case of transmission ellipsometry, both the top and bottom surfaces of the witness should be smooth. (c) For optical reflectance, if the incoherent addition is to be avoided, the witness' bottom surface needs to be roughed; if the incoherent addition is to be included, then the bottom surface should be smooth.

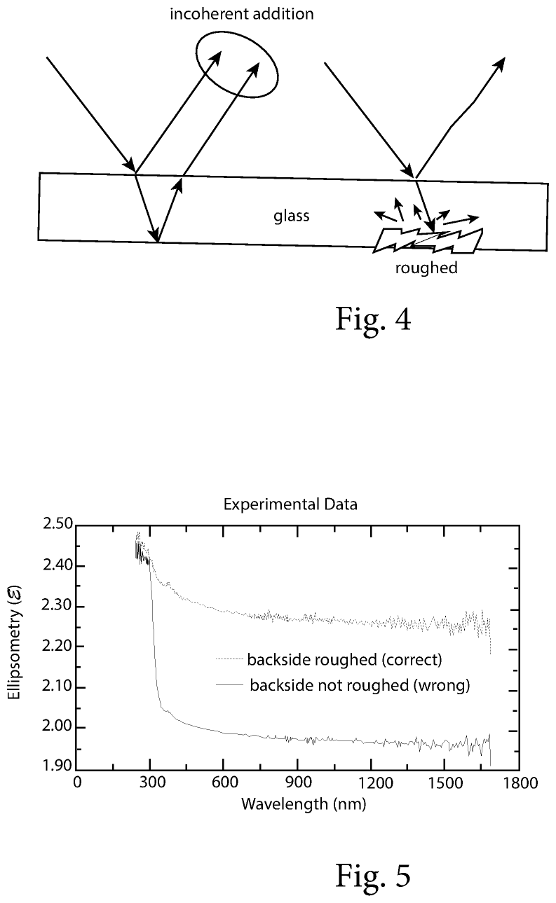

The concept of incoherent addition is depicted in FIG. 4 wherein a first radiation beam is reflected from both the top and bottom surfaces of glass with a smooth bottom surface resulting in incoherent addition. Also shown is a second radiation beam that is reflected from the top surface of the glass, but does not have a specular or collimated reflection from the bottom surface as the bottom surface is roughed. The roughened surface scatters the beam reflection. The second radiation beam has only a single reflection and does not experience incoherent addition. FIG. 5 is a graph of experimental data obtained from testing of the phenomenon shown in FIG. 4 which illustrates the large discrepancy whether the bottom surface is smooth or roughened.

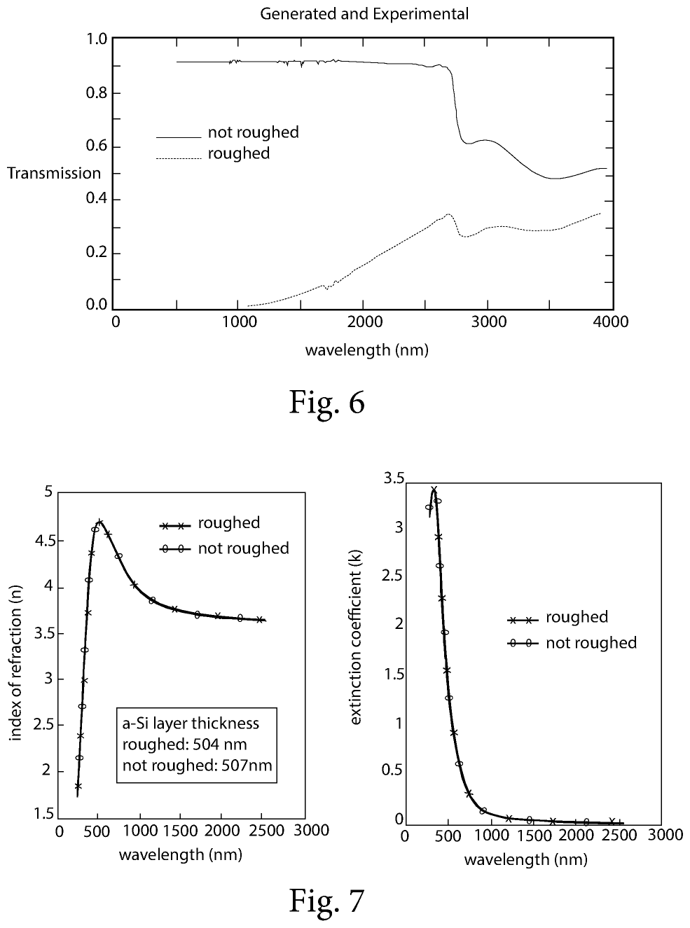

The roughness on the back surface of the witness should be large enough such that the incoherent addition is suppressed, and at the same time small enough such that, even the majority of the light going through the witness may be scattered to all directions, a non-negligible collimated beam still exists that can reach a detector at a distance. It has been found that these two requirements can be met simultaneously. In fact the normal incidence transmission of the roughed sample of FIG. 4 is shown in FIG. 6, compared with glass substrate whose backside is not roughed. As can be seen, both good ellipsometry data in the ellipsometer wavelength range of 250-1700 nm and non-negligible transmission data in the IR wavelength of >1000 nm (where most ICE's work) are obtained from the same witness sample. This sample is also suitable for intensity reflectance measurement.

The amount of roughness on the back surface of the witness should be large enough that the backside diffusely scatters the incident light, i.e., there is no or negligible amount of specular or collimated reflection from the backside. The roughness on the back surface of the witness should be small enough such that there is a detectable amount of light transmitted through the witness and incident on the downstream detector. If the backside is too rough, the detector may not see any transmitted light, making the transmission measurement unavailable. A method of determining the optimum roughness is to measure the amount of specular or collimated reflection from the backside of the witness and the detectable amount of light transmitted through the witness, both with and without backside roughened, using ellipsometry and optical transmission. If no or negligible depolarization effect is present in the ellipsometry data (in contrast to FIG. 5) and optical transmission is non-zero throughout the spectral range of interest (see FIG. 6), then the roughness is in an acceptable range.

In FIG. 6, the transmission spectrum of the roughed glass substrate is significantly lower than the transmission of the glass substrate not roughed, due to the strong scattering effect, which is expected. However, as long as the absolute transmission is measureable (not equal or lower than the noise), the scattering effect can be properly accommodated in the modeling of the later-deposited films by applying a wavelength-dependent reduction factor that is pre-determined from analyzing the bare glass substrates before any film is deposited. Similarly, for optical reflectance measurements, backside scattering can also be accommodated in the modeling of later-deposited films by applying a wavelength-dependent modification factor that is pre-determined from analyzing the bare glass substrates prior to any deposition.

### Example 1

After pre-determining the modification factors described above, a layer of amorphous silicon (a-Si, a material used in the ICE products) was co-deposited on two witness samples: one having a roughed back and the other retaining a smooth back. Ellipsometry data was taken on the roughed sample and intensity transmission data were taken on both samples. Conventionally, the transmission data on the roughed sample is not measured or analyzed as it is considered to have no value). Correspondingly, the conventional approach of data analysis involves ellipsometry on the rough sample and transmission on the smooth sample. The new approach of data analysis of this disclosure involves both ellipsometry and transmission on the same roughed sample. To compare the results, the most important parts of the analysis output: the index of refraction n; the extinction coefficient k; and thickness of the a-Si film d; are shown in FIG. 7 for these two approaches. Good agreement was observed, indicating that the new approach is at least as good as the previous approach, but with a simplified witness/measurement setup. More importantly, the quality of the conventional approach is dependent on a weak inter-sample non-uniformity, as shown in FIG. 6, and a relatively simple film structure. If the inter-sample non-uniformity is worse (which is true for many systems) or as the multi-layer structure becomes more complicated (which is true for many systems), the quality of the conventional approach may degrade because it may no longer be valid to assume that the films on two different witness samples have the same properties. The new approach disclosed herein, however is much less vulnerable to such a problem, as all the optical measurements are performed on a single sample. The intra-sample non-uniformity, if not zero, is much smaller than the inter-sample non-uniformity.

An embodiment of the present disclosure is a method of reducing the number of witness samples to one for multiple types of optical measurements. The benefits can include reduced witness spots, expanded measurement varieties, simplified sample setup, reduced modelling ambiguities, increased parameter accuracy, and improved process monitor and control capabilities. The overall methodology described in this invention provides a relatively easy approach with clear, significant, and positive results. It can be applied to thin film fabrication processes widely used in the industry and academia.

The conventional approach uses multiple witness samples, each for one type of optical measurement, while the present disclosure requires only a single witness sample that is used for multiple optical measurements. The conventional approach has stronger parameter correlations and larger uncertainty in the optical modeling, while the present disclosure has less parameter correlation and a lower uncertainty in optical modeling. The conventional approach is vulnerable to process non-uniformity, while the present disclosure much less vulnerable to process non-uniformity. In the conventional approach a backside roughened witness is not suitable for optical transmission analysis, while with the present disclosure a backside roughened witness is used for all optical analysis including transmission analysis, reflectance analysis and ellipsometry analysis.

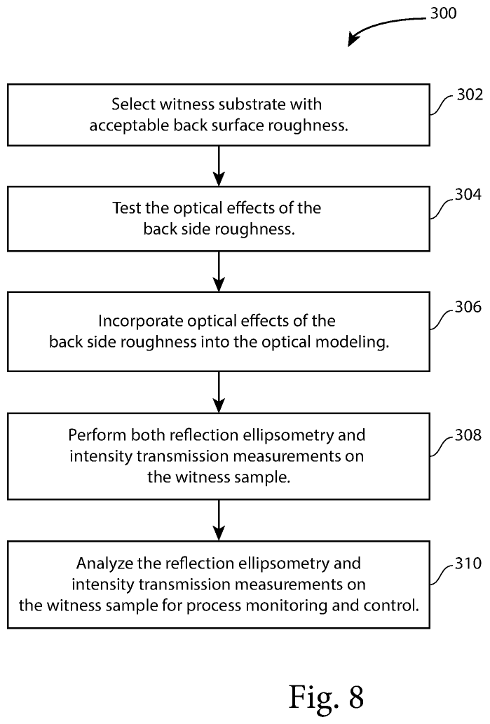

Referring now to FIG. 8, illustrated is a schematic flowchart that provides an exemplary method 300 of utilizing a roughened witness sample while manufacturing an ICE core, according to one or more embodiments. As illustrated, the method 300 may first include selecting a witness substrate having a back surface that is “properly” roughed 302 and then testing the optical effects of the backside roughness 304. The optical effects of the backside roughness are then taken into account during the optical modeling of the ICE core 306. During the manufacturing process both reflection ellipsometry and intensity transmission measurements are performed on the witness sample 308. The reflection ellipsometry and intensity transmission measurements on the witness sample are then analyzed for use in process monitoring and control 310.

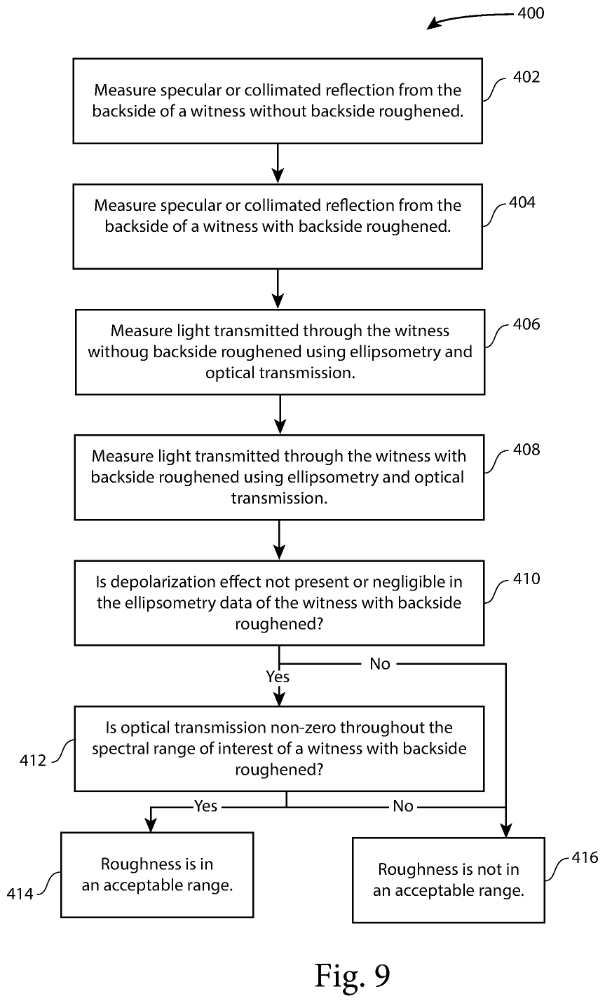

Referring now to FIG. 9, illustrated is a schematic flowchart that provides an exemplary method 400 of determining whether a roughened witness sample of an ICE core has roughness within an acceptable range, according to one or more embodiments. As illustrated, the method 400 may first include measuring specular or collimated reflection from the backside of a witness without backside roughened 402 and then measuring specular or collimated reflection from the backside of a witness with back side roughened 404. The method further measures light transmitted through the witness without backside roughened using ellipsometry and optical transmission 406, and then measures light transmitted through the witness with backside roughened using ellipsometry and optical transmission 408. If the depolarization effect is not present or is negligible in the ellipsometry data of the witness with backside roughened 410 and optical transmission is non-zero throughout the spectral range of interest of the witness with backside roughened 412 then the roughness is within an acceptable range 414. If either the depolarization effect is present and non-negligible in the ellipsometry data of the witness with backside roughened 410 or optical transmission is zero throughout the spectral range of interest of the witness with backside roughened 412 then the roughness is not within an acceptable range 416.

Some of the benefits to the disclosed method are improved process monitoring and control, increased parameter accuracy and reduced modelling ambiguities. Having reduced witness sample spots should simplify sample setup and result in lower witness associated costs.

An embodiment of the present disclosure is an optical device fabrication system that includes a witness sample having a roughened backside, wherein when the witness sample is subjected to electromagnetic radiation, optical measurement data is generated from the witness sample. In an embodiment the system includes a single witness sample generating optical data when subjected to electromagnetic radiation. In an embodiment the system includes a single witness sample generating transmission data when subjected to electromagnetic radiation. In an embodiment the system includes a single witness sample generating reflectance data when subjected to electromagnetic radiation. In an embodiment the system includes a single witness sample generating ellipsometry data when subjected to electromagnetic radiation. In an embodiment the optical device is an integrated computing element core. In an embodiment the witness sample has a roughened backside with roughness wherein depolarization effect is not present or is negligible in the ellipsometry and optical transmission. In an embodiment the witness sample has a roughened backside with roughness wherein optical transmission is non-zero throughout the spectral range of interest. In an embodiment the optical transmission and ellipsometry measurement data obtained from the witness sample can be utilized for in-situ process monitoring and control in the manufacture of optical thin film coatings on an optical device.

An alternate embodiment of the present disclosure is a method for fabricating optical thin film coatings that includes: providing a witness sample having a roughened backside, subjecting the witness sample to electromagnetic radiation, obtaining optical measurement data generated from the witness sample, and utilizing the optical measurement data from the witness sample for data analysis and in-situ process monitoring in the manufacture of optical thin film coatings on an optical device. An embodiment of the method includes a single witness sample that is solely used for in-situ process monitoring. In an embodiment the optical measurement data includes both transmission and reflectance data. In an embodiment the optical measurement data includes both transmission and ellipsometry data. In an embodiment the optical measurement data includes transmission, reflectance, and ellipsometry data. In an embodiment the optical device is an integrated computing element core. In an embodiment the in-situ process monitoring includes characterizing the deposition process simultaneously with film thickness and optical properties. In an embodiment the method further includes measuring a reduction factor in the optical transmission intensity data arising from the witness sample having a roughed backside. In an embodiment the method further includes utilizing the reduction factor of the witness sample for data analysis to determine an optical thin film thickness and optical properties.

An alternate embodiment of the present disclosure is a method for fabricating optical thin film coatings that includes: providing a single witness sample having a roughened backside, measuring a reduction factor in the optical transmission intensity data arising from the witness sample having a roughened backside, subjecting the witness sample to electromagnetic radiation, obtaining measurement data generated from the witness sample that includes more than one type of optical data selected from transmission, reflectance, and ellipsometry data, utilizing the reduction factor of the witness sample and optical measurement data from the witness sample for data analysis to determine an optical thin film thickness and optical properties, and utilizing the reduction factor of the witness sample and optical measurement data from the witness sample for in-situ process monitoring in the manufacture of optical thin film coatings on an optical device. In an embodiment the optical device is an integrated computing element core.

The operations of the steps are described with reference to the systems/apparatus shown described herein. However, it should be understood that the operations of the steps could be performed by embodiments of systems and apparatus other than those discussed herein and are not meant to be limiting. Embodiments discussed herein could perform alternate operations different than those discussed but achieving substantially similar results.

The text above describes one or more specific embodiments of a broader disclosure. The disclosure also is carried out in a variety of alternate embodiments and thus is not limited to those described here. The foregoing description of an embodiment of the disclosure has been presented for the purposes of illustration and description. It is not intended to be exhaustive or to limit the disclosure to the precise form disclosed. Many modifications and variations are possible in light of the above teaching. It is intended that the scope of the disclosure be limited not by this detailed description, but rather by the claims appended hereto.

What is claimed is:

1. An optical device fabrication system, comprising:
a witness sample having a roughened backside;
wherein optical measurement data is generated by the witness sample in response to subjecting the witness sample with roughened backside to electromagnetic radiation.

2. The system of claim 1, wherein the system comprises a single witness sample generating optical data when subjected to electromagnetic radiation.

3. The system of claim 1, wherein the system comprises a single witness sample generating transmission data when subjected to electromagnetic radiation.

4. The system of claim 1, wherein the system comprises a single witness sample generating reflectance data when subjected to electromagnetic radiation.

5. The system of claim 1, wherein the system comprises a single witness sample generating ellipsometry data when subjected to electromagnetic radiation.

6. The system of claim 1, wherein the optical device is an integrated computing element core.

7. The system of claim 1, wherein the witness sample provides ellipsometry data with negligible depolarization effect when subjected to electromagnetic radiation.

8. The system of claim 1, wherein the witness sample provides non-zero optical transmission when subjected to electromagnetic radiation.

9. The system of claim 1, wherein the optical transmission and ellipsometry measurement data obtained from the witness sample can be utilized for in-situ process monitoring and control in the manufacture of optical thin film coatings on an optical device.

10. A method for fabricating optical thin film coatings comprising:
providing a witness sample having a roughened backside;
subjecting the witness sample to electromagnetic radiation;
generating optical measurement data from the witness sample; and
utilizing the optical measurement data from the witness sample for data analysis and in-situ process monitoring in the manufacture of optical thin film coatings on an optical device.

11. The method of claim 10, wherein a single witness sample is solely used for in-situ process monitoring.

12. The method of claim 10, wherein the optical measurement data comprises both transmission and reflectance data.

13. The method of claim 10, wherein the optical measurement data comprises both transmission and ellipsometry data.

14. The method of claim 10, wherein the optical measurement data comprises transmission, reflectance, and ellipsometry data.

15. The method of claim 10, wherein the optical device is an integrated computing element core.

16. The method of claim 10, wherein the in-situ process monitoring comprises characterizing the deposition process simultaneously with film thickness and optical properties.

17. The method of claim 10, further comprising, measuring a reduction factor in the optical transmission intensity data arising from the witness sample having a roughed backside.

18. The method of claim 17, further comprising utilizing the reduction factor of the witness sample for data analysis to determine an optical thin film thickness and optical properties.

19. A method for fabricating optical thin film coatings comprising:
providing a single witness sample having a roughened backside;
measuring a reduction factor in the optical transmission intensity data arising from the witness sample having a roughened backside;
subjecting the witness sample to electromagnetic radiation;
generating measurement data from the witness sample that includes more than one type of optical data selected from transmission, reflectance, and ellipsometry data;
utilizing the reduction factor of the witness sample and optical measurement data from the witness sample for data analysis to determine an optical thin film thickness and optical properties;
utilizing the reduction factor of the witness sample and optical measurement data from the witness sample for in-situ process monitoring in the manufacture of optical thin film coatings on an optical device.

20. The method of claim 19, wherein the optical device is an integrated computing element core.
